(19) United States
(12) Patent Application Publication
(10) Pub. No.: US 2011/0080739 A1
(43) Pub. Date: Apr. 7, 2011

(54) Light with Replaceable Light Source

(76) Inventors: Totada R. Shantha, McDonough, GA (US); Shaam P. Sundhar, Princeton, NJ (US)

(21) Appl. No.: 12/572,275

(22) Filed: Oct. 2, 2009

(51) Int. Cl. F21V 29/00; F21V 3/00

(52) U.S. Cl. 362/294; 362/363

(57) ABSTRACT

A light with replaceable light source has a base that fits within a standard light socket. The base has a threaded portion that is adapted to receive a complementary threaded portion in an outer protective bulb. The base holds a plug used to removably attach a sealed inner bulb. There is a plurality of holes in the outer bulb to allow air to flow therein. The sealed inner bulb is replaced as needed. Additionally, the inner sealed bulb may be an incandescent, CFL or LED. In one embodiment, a sensor is provided to provide automatic operation. In another embodiment, three-way functionality is provided. Replacement sealed bulbs may be provided in a bulk pack to further economize.

### BACKGROUND OF THE INVENTION

Light has always been very important in human history. Of course the sun and the moon were the main sources of light supplemented with fire until very recent times. With the discovery of electricity and its subsequent harnessing, other forms of light became available starting with the electric arc and of course with the history changing incandescent light that is so closely associated with Thomas Edison.

While the incandescent light bulb revolutionized modern times, they have drawbacks which are also shared with some recent replacements such as compact fluorescent lights (CFL) and bright light emitting diodes (LED), namely that they can all need to be replaced. This involves replacing the entire bulb in most applications.

There is a need for a light bulb that allows the light source to be replaced without discarding the entire light bulb.

### SUMMARY OF THE INVENTION

A light with replaceable light source has a base that fits within a standard light socket. The base has a threaded portion that is adapted to receive a complementary threaded portion in an outer protective bulb. The base holds a plug used to removably attach a sealed inner bulb. There is a plurality of holes in the outer bulb to allow air to flow therein. The sealed inner bulb is replaced as needed. Additionally, the inner sealed bulb may be an incandescent, CFL or LED. In one embodiment, a sensor is provided to provide automatic operation. In another embodiment, three-way functionality is provided. Replacement sealed bulbs may be provided in a bulk pack to further economize.

Other features and advantages of the instant invention will become apparent from the following description of the invention which refers to the accompanying drawings.

### BRIEF DESCRIPTION OF THE DRAWINGS

FIG. 1 is a cutaway view of a light with replaceable light source according to an embodiment of the present invention.

FIG. 2 is an exploded view of the light with the replaceable light source shown in FIG. 1.

FIG. 3 is a cutaway view of the light with the replaceable light source shown in FIG. 1 having an automatic sensor.

FIG. 4 is a cutaway view of the light with the replaceable light source shown in FIG. 1 having two filaments.

FIG. 5 is a cutaway view of the light with the replaceable light source shown in FIG. 1 having a reflector.

FIG. 6 is an illustration of a blister pack of replacement light sources used in the embodiment shown in FIG. 1.

FIG. 7 is a cutaway view of the light with the replaceable light source shown in FIG. 1 having an LED replaceable light source.

FIG. 8 is an exploded view of the light with the replaceable light source shown in FIG. 7.

FIG. 9 is a cutaway view of the light with the replaceable light source shown in FIG. 1 having a CFL replaceable light source.

FIG. 10 is an exploded view of the light with the replaceable light source shown in FIG. 9.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

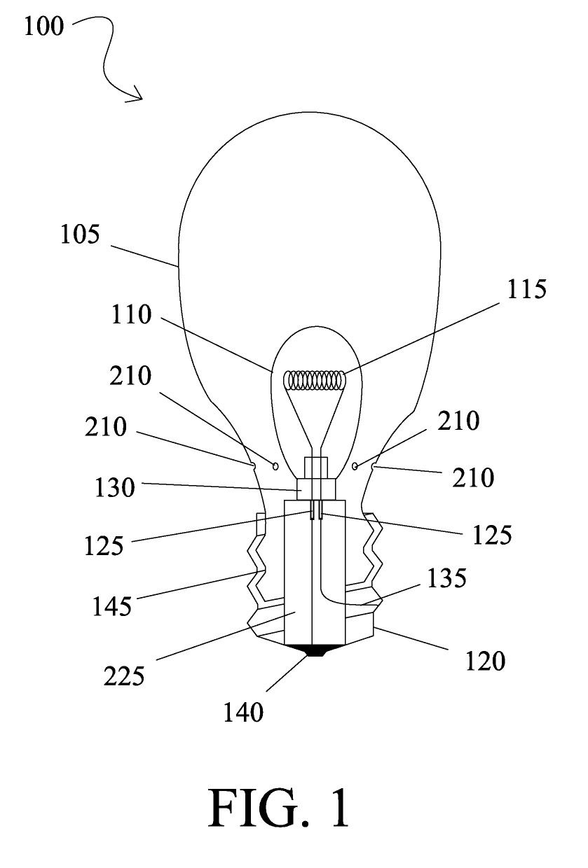

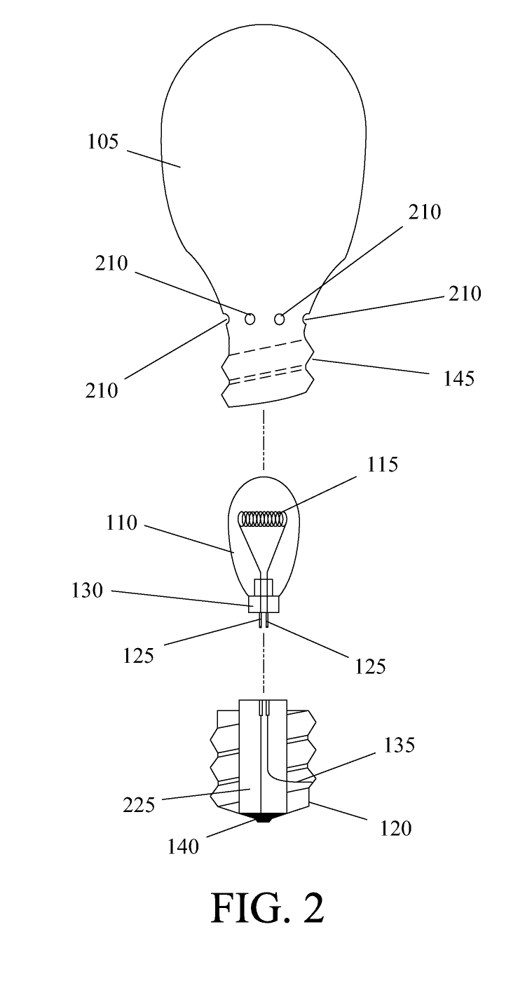

Referring to FIGS. 1 and 2, a light with replaceable light source 100 is shown having a base 120 that screws into a standard light socket (not shown). The most popular light socket is known as an E26 medium base. Other sizes include E12 (Candelabra), E39 (Mogul) and of course vehicles use a great variety of sockets. Base 120 has a base contact 140 and a side contact 135 that completes a circuit to energize the light when in use as is known in the art. An outer bulb 105 is used to protect a sealed inner bulb 110. Outer bulb 106 is not sealed and has a plurality of holes 210 used to allow air to flow in and out. Sealed inner bulb 110 has a filament 115 and an inner bulb base 130. Inner bulb base 130 has two plugs 125 that removably fit within a base socket 225. Of course other plug systems may be used such as key hole slots (not shown) which are inserted and then twisted to lock in place.

Outer bulb 105 has a threaded portion 145 that threads in base 120 to securely hold it therein while allowing removal by unscrewing, replacing sealed inner bulb 110 and then screwing outer bulb 105 back in. This is clearly shown in FIG. 2.

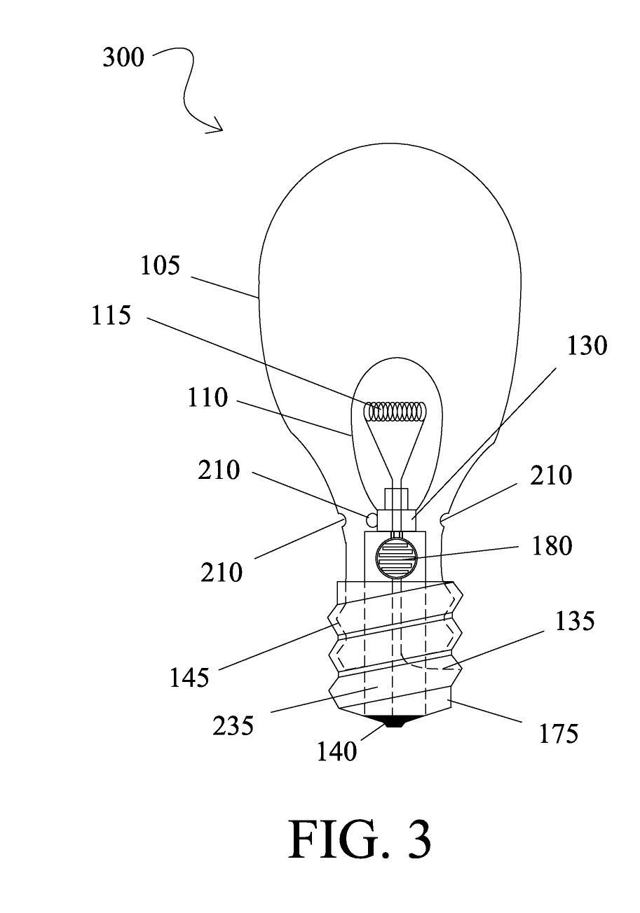

Now referring to FIG. 3, a light with replaceable light source 300 is shown having a base 175. As described above, base 175 has base contact 140 and side contact 135. Base 175 has a base socket 235 that includes a sensor 180 to automatically turn on and off in response to ambient light levels. Additionally sensor 180 could be a motion sensor as is known in the art. As described above, outer bulb 105 includes a plurality of holes 210 and threaded portion 145. Sealed inner bulb 110 operates as described above.

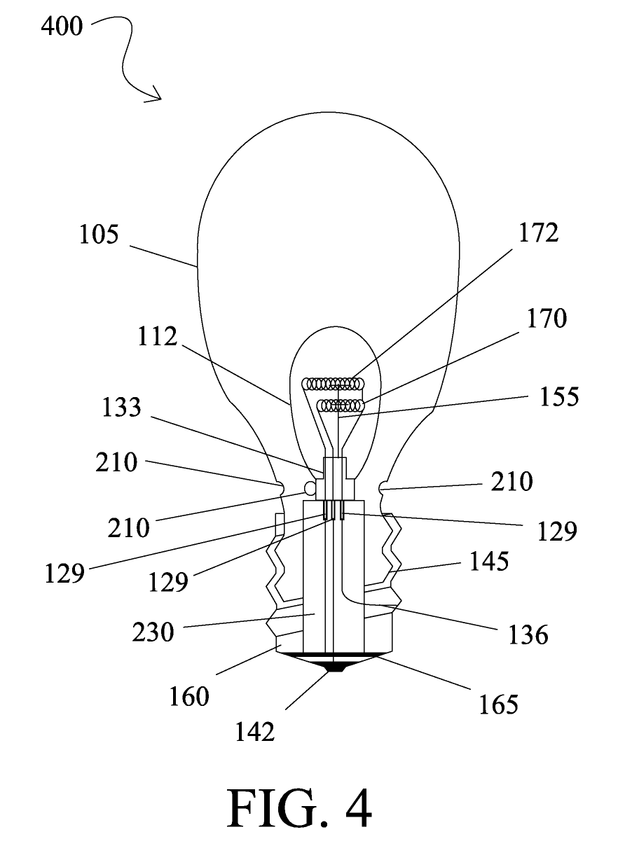

Referring now to FIG. 4, a light with replaceable light source 400 is shown having a three-way base 160. Three-way base 160 has a first base contact 142, a second base contact and a side contact 136 used to control three-way functionality as is known in the art. Three-way base 160 has a three-way base socket 230. An inner three-way bulb base 133 fits within three-way base socket 230. A sealed three-way inner bulb has a first and second filament 170 and 172 respectively which are selectively energized to provide three-way functionality as is known in the art. A support wire 155 is used to support first and second filaments 170 and 172.

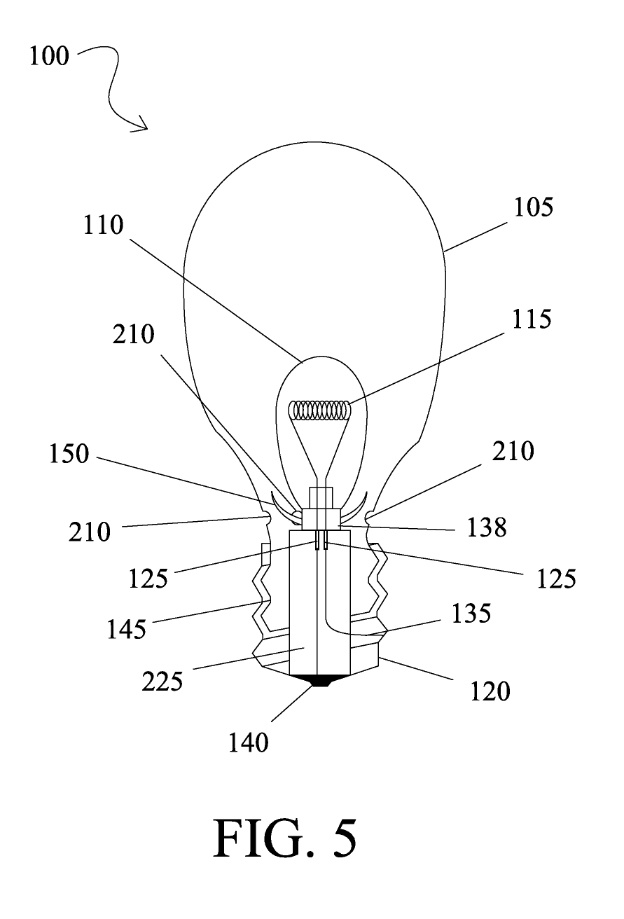

Referring to FIG. 5, a light with replaceable light source 500 is shown having a base 120. As described above, base 120 has base contact 140 and side contact 135. A reflector 150 fits over an inner bulb base 138 to direct the light to increase the usable illumination.

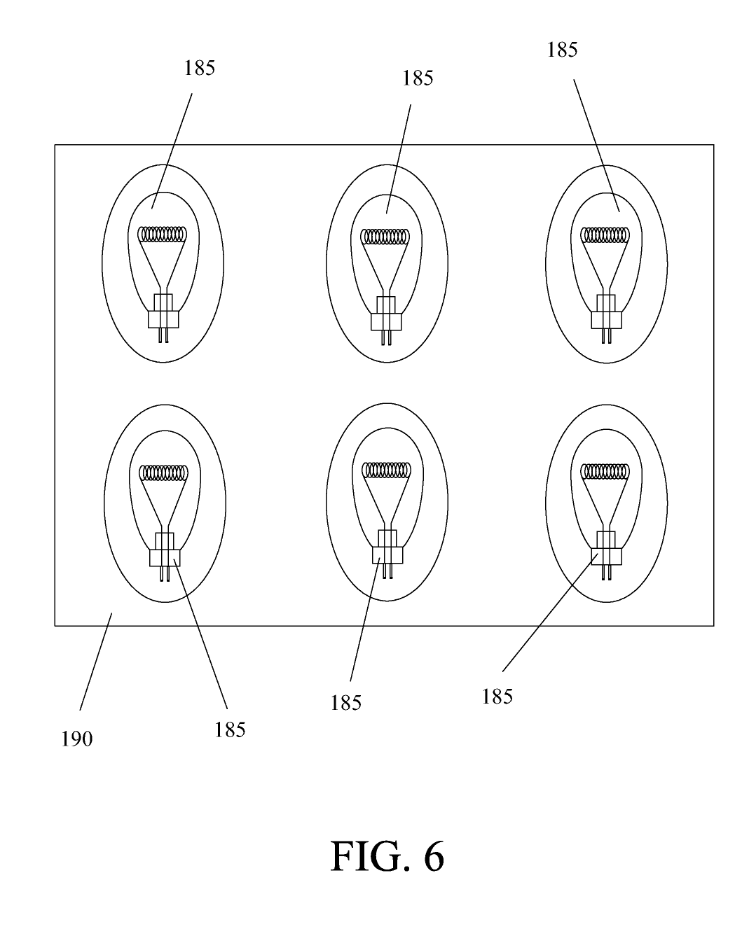

FIG. 6 is an illustration showing a blister pack 190 of replacement sealed inner bulbs 185. The user replaces these sealed bulbs as necessary as discussed above. Of course blister pack 190 could be three-way bulbs, LED lights or even CFLs.

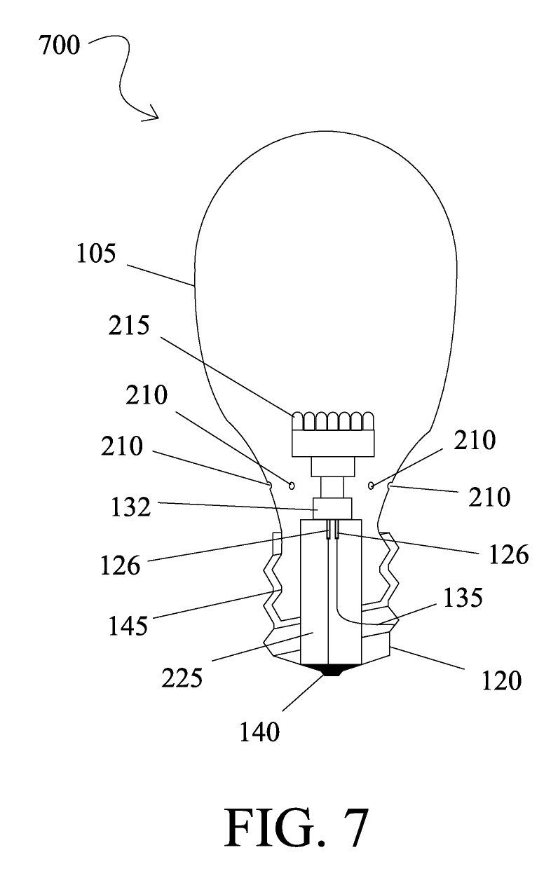

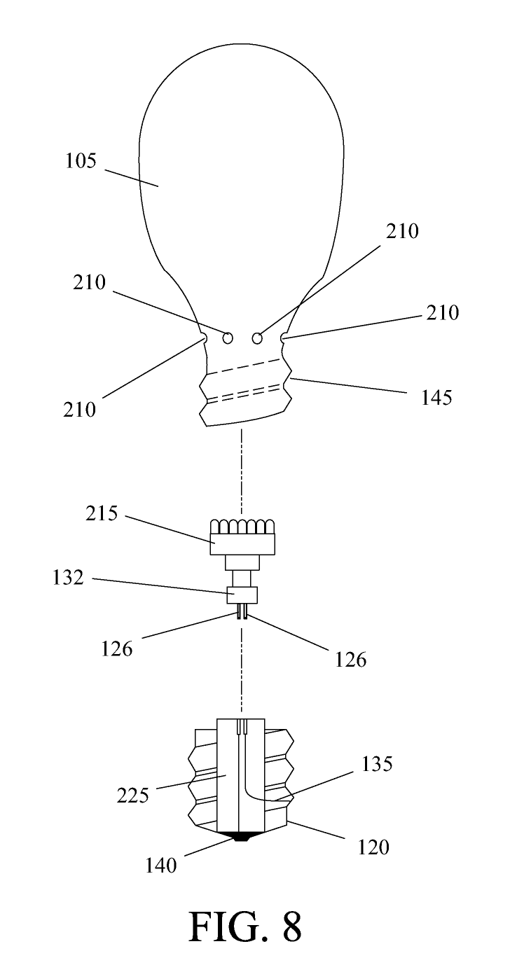

Now referring to FIGS. 7 and 8, a light with replaceable light source 700 is shown having base 120 that screws into a standard light socket (not shown). Base 120 has base contact 140 and side contact 135 as discussed above. Outer bulb 105 is used to protect a sealed LED inner bulb 215. Outer bulb 106 is not sealed and has a plurality of holes 210 used to allow air to flow in and out. Sealed inner LED bulb 215 has a plurality of LEDs to provide illumination and plugs into an inner bulb base 132.

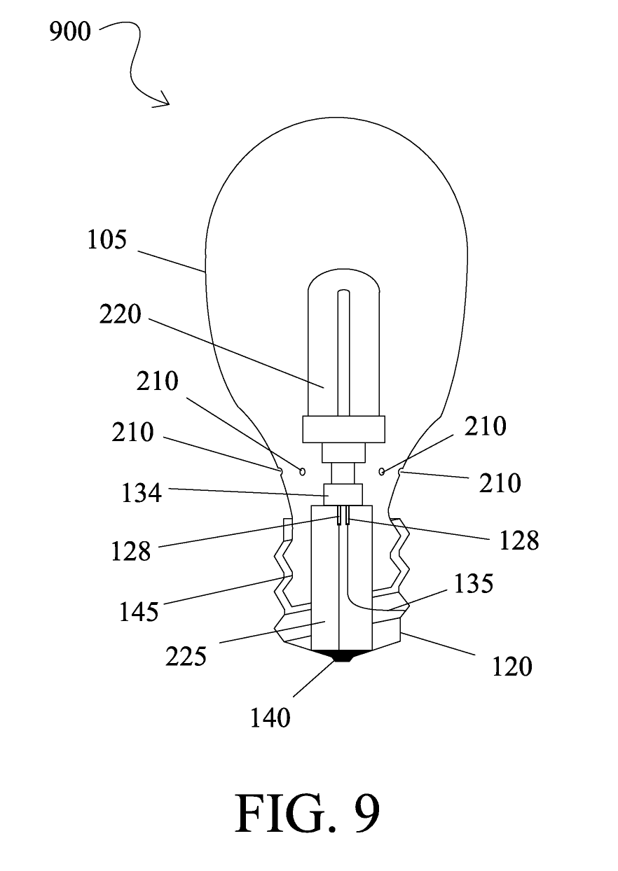

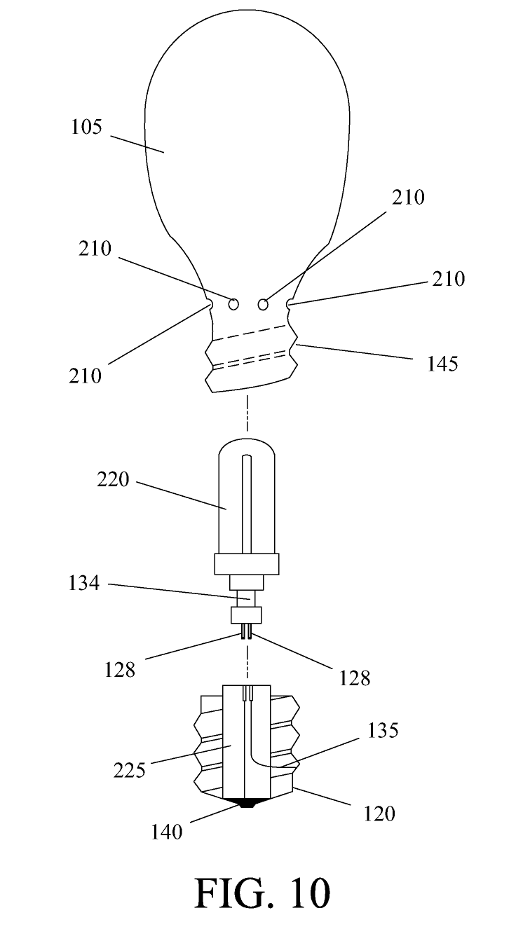

Referring now to FIGS. 9 and 10, a light with replaceable light source 900 is shown having base 120 that screws into a standard light socket (not shown). Base 120 has base contact 140 and side contact 135 as discussed above. Outer bulb 105 is used to protect a sealed inner CFL bulb 220. Outer bulb 106 is not sealed and has a plurality of holes 210 used to allow air to flow in and out. Sealed inner CFL bulb 220 uses compact florescent light to provide illumination and plugs into an inner bulb base 134.

Of course, other kinds of illumination sources may be used to provide illumination as long as it is fitted within the base plug. In an embodiment used in vehicles, a base fits within a plug portion while allowing a user to replace an inner illuminating source. This allows the illumining source to be replaced without the need for tools.

Additionally, base socket 225 can include energy electronics as is known in the art to increase the longevity of the illumination source and to save energy.

Although the instant invention has been described in relation to particular embodiments thereof, many other variations and modifications and other uses will become apparent to those skilled in the art.

What is claimed is:

1. A light with replaceable light source comprises:
a base adapted to fit within a light socket;
an inner sealed bulb having a plug portion;
said bulb having an illumination means for providing light;
a socket portion disposed within said base adapted to receive said plug portion whereby said inner sealed bulb is selectively removable; and
an outer bulb having a portion adapted to fit within said base wherein said outer bulb portion is selectively removable.

2. The light with replaceable light source according to claim 1 wherein said base is threaded.

3. The light with replaceable light source according to claim 1 wherein said standard light socket is an E26 socket.

4. The light with replaceable light source according to claim 1 wherein said standard light socket is an E12 socket.

5. The light with replaceable light source according to claim 1 wherein said standard light socket is an E39 socket.

6. The light with replaceable light source according to claim 1 further comprising at least one ventilation opening disposed in said outer bulb.

7. The light with replaceable light source according to claim 1 further comprising a sensor disposed on said base wherein said sensor is adapted to control said illumination means.

8. The light with replaceable light source according to claim 1 further comprising a reflector circumferentially disposed beneath said illumination means whereby light is reflected in a selective direction.

9. The light with replaceable light source according to claim 1 wherein said illumination means is an incandescent light source.

10. The light with replaceable light source according to claim 1 wherein said illumination means is a CFL.

11. The light with replaceable light source according to claim 1 wherein said illumination means is an LED source.
